(19) United States
(12) Patent Application Publication
(10) Pub. No.: US 2007/0188836 A1
(43) Pub. Date: Aug. 16, 2007

(54) Hologram having authentication information recorded therein

(75) Inventor: Mitsuru Kitamura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DAI NIPPON PRINTING CO., LTD., Tokyo (JP)

(21) Appl. No.: 10/585,306

(22) PCT Filed: Dec. 28, 2004
(86) PCT No.: PCT/JP04/19831

§ 371 Date: Jul. 6, 2006

(30) Foreign Application Priority Data
Jan. 7, 2004 (JP) 2004-001807

(51) Int. Cl. G03H 1/00

(52) U.S. Cl. 359/2

(57) ABSTRACT

The invention relates to a hologram having authenticating information recorded in such a way that the information is little viewable in an ordinary viewing state and an authenticator can easily check the authenticating information from a color difference, and so having high counterfeit-proofness. In a 3D image-reconstructing hologram 10, a minute object 11 that is authenticating information is located behind a shielding block 12 of visually easy-to-perceive size, so that the authenticating information 11 is hidden by the shielding block 12 in a given viewing direction and so is not exposed to view, but can be viewed from a direction different from the given direction. Further, the authenticating information 11 and the shielding block 12 are recorded in such a way as to be viewable in mutually different colors.

### ART FIELD

The present invention relates generally to a hologram that has authenticating information recorded in it, and more particularly to a hologram wherein there is recorded authenticating information that is difficult to view in normal viewing states.

### BACKGROUND ART

So far there have been known counterfeit-proof means for recording authenticating information by printing of as fine patterns as cannot be copied with copiers. However, such counterfeit-proof means are on the way out because recent performance improvements in copiers enable even fine patterns to be copied.

More recently, techniques for forming fine patterns by means of diffraction gratings have been figured out (see patent publication 1), and are now still available as counterfeit-proof means because it is possible to record authenticating information of as fine size as cannot perceive its shape visually.

In any case, the authenticating information is recorded directly on a given recording surface. Therefore, one can immediately see through what information is recorded by observation under a loupe or microscope. Further, if what information is recorded can be seen through, it is then easy to forge that information, because easier access is now given to cheaper devices for recording fine diffraction gratings.

To avoid direct formation of the shape of authenticating information on a recording surface, on the other hand, it has also been attempted to record authenticating information by holography (see patent Publication 2). Holography requires a real-size object, but it is difficult to fabricate an object of visually hard-to-perceive size. For this reason, this patent publication 2 shows an example of the method for implementing lens reductions simultaneously with holography using a negative plane image as a subject.

This holographic method for fabricating a hologram that reconstructs a fine 3D image, however, is practically not preferred because of some restrictions on the size, position, alignment precision, etc. of the object to be used.

On the other hand, a computer-generated hologram (CGH) is fabricated using a computer, for which only the storage as digital data of the shape and location of an object is needed, lightens many such restrictions on the object, and so is desired for the fabrication of minute 3D image-reconstructing holograms.

In this connection, the inventor has already come up with a hologram having authenticating information recorded in it, which comprises a shielding block of visually easy-to-perceive size and a minute object forming the authenticating information which is located behind said shielding block, wherein said minute object is hidden by said shielding block in a given viewing direction such that said minute object cannot be viewed from said given viewing direction and can be viewed from a viewing direction different from said given viewing direction (see Patent Publication 3). According to the invention set forth in Patent Publication 3, there can be provided a hologram that ensures high concealability for the authenticating information and is much less vulnerable to illegal copying, because even if the hologram is irradiated with proper illumination light, the presence of the recorded authenticating information is much less noticeable (because that authenticating information is of as fine size as cannot be perceptible to the naked eye), and because even upon observation under a loupe or the like, the presence of the authenticating information is much less noticeable from the front direction that is a normal viewing direction.
Patent Publication 1
Registered Utility Model No. 2,582,847
Patent Publication 2
JP-A 11-21793
Patent Publication 3
JP-A 2003-228270
Patent Publication 4
Japanese Patent Application No. 2000-214751
Patent Publication 5
JP-A 2-165987
Patent Publication 6
U.S. Pat. No. 4,568,141
Patent Publication 7
JP-A 6-266274
Patent Publication 8
JP-A 6-110370
Non-Patent Publication 1
   “99-3D Image Conference ‘99”, a CD-ROM version of lecturing monographs (at the Shinjuku schoolhouse, Kogakuin University), an article entitled “Image-type binary CGH by means of EB printing (3)—Enhancement of 3D effect with hidden surface removal and shading—”

With the hologram set forth in patent publication 3, wherein the minute object that is the authenticating information is located behind the shielding block of visually easy-to-perceive size, however, it is found to be not necessarily easy for an authenticator to look into and check up the authenticating information, because upon viewing the authenticating information comes out of behind the shielding block.

### SUMMARY OF THE INVENTION

In view of such problems with the prior art as explained above, an object of the present invention is to provide a hologram having authenticating information recorded therein in such a way that it is substantially difficult to view in a normal viewing state and it is easy for an authenticator to check up the authenticating information through a color difference, and so having improved counterfeit-proofness.

According to the present invention, this object is achieved by the provision of a 3D image-reconstruction hologram having authenticating information recorded therein, characterized in that:

a minute object that is the authenticating information is located behind a shielding block of visually easy-to-perceive size, so that the authenticating information is hidden by the shielding block in a given viewing direction and so is not exposed to view, but can be viewed from a direction different from said given direction, and said authenticating information and said shielding block are recorded in such a way as to be viewable in mutually different colors.

Preferably, the minute object is of visually difficult-to-resolve size, and is viewable through a magnifying viewing means.

Preferably, the given direction is a front direction with respect to said hologram.

Preferably, the hologram is recorded in a computer-generated hologram form.

Preferably, the minute object has a maximum size of 300 μm or less.

The shielding block may comprise a pattern constructed of a diffraction grating recorded in a hologram surface.

The minute object may be in a character form.

The minute object may have an angle of radiation of object light, at which the minute object is fully visible on one side of the shielding block.

The distance between the minute object and the shielding block may be determined such that the minute object is fully visible on one side of the shielding block in a direction different from the given direction.

The minute object may be invisible on one side that is opposite to the other side on which the minute object is fully visible.

Preferably, the angle range in which the minute object is partly or wholly visible is equal to or narrower than the angle, range in which the minute object is hidden by the shielding block, more preferably ½ of that angle range.

In another embodiment of the present invention, another minute object may be recorded therein such that said another minute object is viewable on one side that is opposite to the other side on which the minute object is fully visible.

Preferably, the minute object is reconstructed within 1 mm from the surface of the hologram.

The holograms of the present invention may be applied onto a card or a document.

The present invention also includes an authenticating information check system, wherein an illumination optical system and a viewing position are provided such that the minute object in the hologram having authenticating information recorded therein is viewable.

In the authenticating information check system of the present invention, the hologram and the illumination optical system are fixedly provided while the viewing position is relatively movable; the illumination optical system and the viewing position are fixedly provided while said hologram is relatively rotatable; the hologram and the viewing position are fixed provided while the illumination optical system is relatively movable; and the like.

Further, the present invention includes a card or a document onto which the hologram having authenticating information recorded therein is applied.

### BRIEF DESCRIPTION OF THE DRAWINGS

FIG. 1 is illustrative of a minute object and a shielding block recorded in the hologram of the invention and the range of object light.

FIG. 2 is illustrative of one arrangement of the invention, wherein the minute object is recorded in such a way as to be fully viewable on one side of the shielding block.

FIG. 3 is illustrative of another embodiment of the invention, wherein the minute object is fully viewable on one side but is fully hidden on the other side and so not exposed to view.

FIG. 4 is illustrative of yet another arrangement of the invention, wherein when two minute objects are recorded, one is fully visible on one side and another is fully visible on the other side.

FIGS. 5(a), 5(b) and 5(c) are illustrative of exemplary authenticating information check systems according to the invention.

FIG. 6 is a flowchart illustrative of a specific CGH fabrication process.

FIG. 7 is illustrative of hidden surface removal processing in the case of a CGH.

FIG. 8 is illustrative of one mode for recording an object in the same CGH such that the image of the object is reconstructed at a plurality of wavelengths.

### BEST MODE FOR CARRYING OUT THE INVENTION

In the inventive hologram having authenticating information recorded therein, the minute object that is the authenticating information cannot be viewed in a given viewing direction but can be viewed only in a certain viewing direction different from that direction. For instance, the authenticating information or minute object is gradually visible from behind the shielding block.

The hologram having authenticating information recorded in it according to the present invention is now explained with reference to patent publication 3. Although the inventive hologram may be fabricated by ordinary holography as described later, it should preferably be fabricated by computer generation. Thus, a computer-generated hologram (CGH) is first explained.

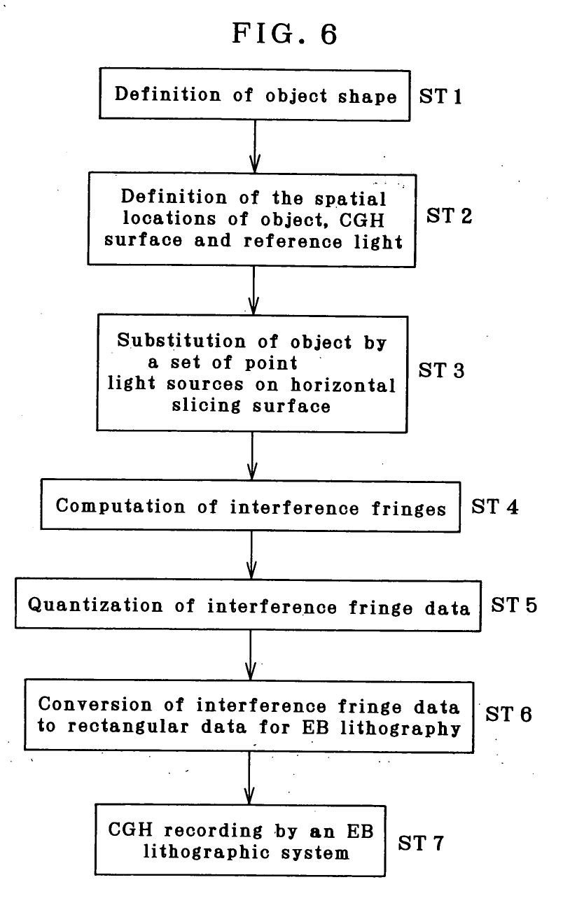

How to fabricate CGHs is well known (from, for instance, non-patent publication 1). As an exemplary CGH, a binary hologram obtained by recording an intensity profile of interference fringes is explained. Reference is briefly made to the case wherein a reconstructed image having parallax in the horizontal direction only is observed while illuminated with white light coming from above. As shown in FIG. 6, the shape of an object from which a CGH is obtained is defined at step ST1. At step ST2, the spatial locations of the object, a CGH surface and reference light are then defined. At step ST3, the object is vertically divided by slicing on a horizontal surface, and then substituted on the slicing surface by a set of point light sources. In step ST4, at each sample point defined on the CGH surface, the intensity of an interference fringe of object light coming from each light source forming a part of the object and reference light is computed on the basis of such spatial locations, thereby obtaining interference fringe data. Subsequently, the obtained interference fringe data are quantized at step ST5, and then converted to rectangular data for EB lithography. Finally at step ST7, the data are recorded in a medium by an EB lithography system, so that a CGH is obtained.

In the computation of interference fringes, the “hidden surface removal” processing is implemented in such a way that when an object is viewed from a certain visual point, a portion of the object hidden by another object placed in front thereof is invisible. By this processing, information of the object that is overlapping is added to a retinal image, applying a 3D appearance thereto. For CGH recording, the hidden surface removal processing is carried out by the following steps.

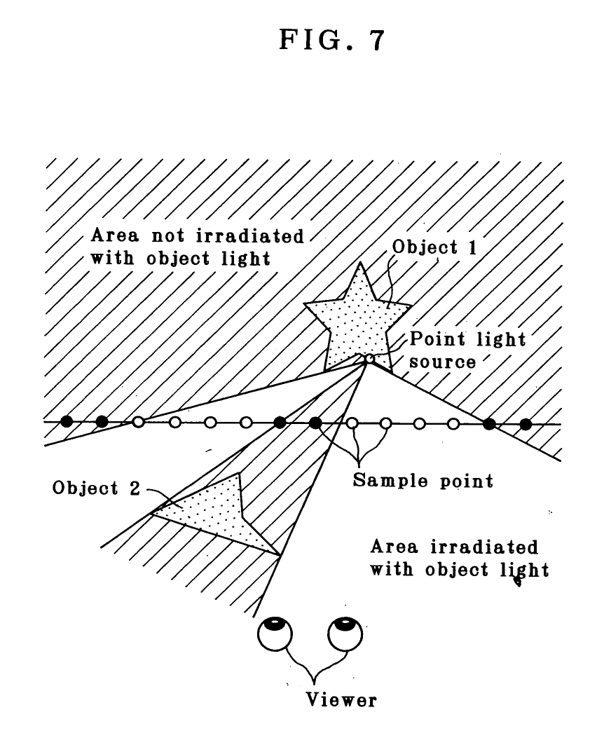

For each of point light sources that form an object 1, an area (hatched in FIG. 7) where that light point source is hidden by objects 1 and 2 is found as shown in FIG. 7. In the case of a computer-generated hologram fabricated at the steps of FIG. 6, the objects 1, 2 are sliced on a horizontal surface and have parallax in the horizontal direction alone, and so an area of point light sources for the object 1 hidden by the objects 1, 2 is found from the positions of points and segments on each slice surface. When interference fringe sampling points distributed on a CGH surface are included in the aforesaid area where the point light sources are hidden (shown by black circles in FIG. 7), those sampling points for the point light source are out of computation of interference fringe intensity. This is the hidden surface removal processing. Reconstructing light from the image of the object 1 reconstructed from the thus processed CGH is not diffracted at the hatched area of FIG. 7, so that when the visual point of a viewer comes in that area, the area of the object 1 corresponding to that point light source is invisible because of being hidden by the image of the object 2.

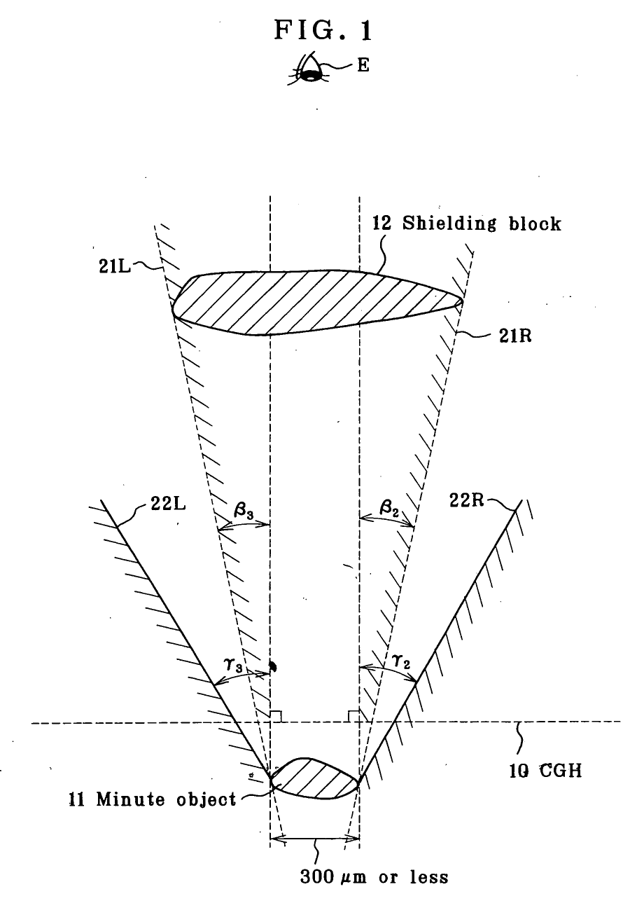

To achieve the hologram of the invention, there is provided a minute object 11 used as authenticating information of visually difficult-to-resolve size, specifically, a character or the like of maximum size of 300 μm or less, as depicted in FIG. 1. Then, a shielding block 12 that is larger than the minute object 11 and of visually easy-to-perceive size is located at a position where the front of the minute object 11 can be hidden in such a way that a viewer E cannot view the minute object 11 from the front (from an ordinary viewing direction), that is, at a specific position in front of the CGH 10. For this reason, the aforesaid hidden surface removal processing is applied to a set of point light sources representing the minute object 11, and then CGH recording is implemented while holding back diffraction of at least reconstructing light from the minute object 11 between a straight line 21L and a straight line 21R in FIG. 1. Here the straight lines 21L is defined by a straight line passing by the left end of the minute object 11 and the left end of the shielding block 12, and the straight line 21R is defined by a straight line passing by the right end of the minute object 11 and the right end of the shielding block 12, with the front direction included between the straight line 21L and the straight line 21R. In FIG. 1, a straight line 22L is drawn upwardly and obliquely from the left end of the minute object 11, indicating a boundary line at a left-hand area of which there is no diffraction of reconstructing light from the left end of the minute object 11, and a straight line 22R is drawn upwardly and obliquely from the right end of the minute object 11, indicating a boundary line at a right-hand area of which there is no diffraction of reconstructing light from the right end of the minute object 11. It is here noted that when the minute object 11 has a minimum size of 25 μm or less, it is just only difficult to resolve the reconstructed hologram image pattern, but it is also difficult to identify that fine pattern even with a simple magnifying means such as a loupe; the minimum size of the minute object 11 is preferably greater than 25 μm.

The foregoing explanation is the same as in patent publication 3, and according to the present invention, the shielding block 12 and the minute object 11 are recorded in different colors. For instance, the hologram recording is implemented such that the shielding block 12 is reconstructed in red with diffracted light having a red wavelength, and the minute object 11 is reconstructed in blue with diffracted light having a blue wavelength. Although the “different colors” means different hues, and different color saturations, it is desired that the hue is different.

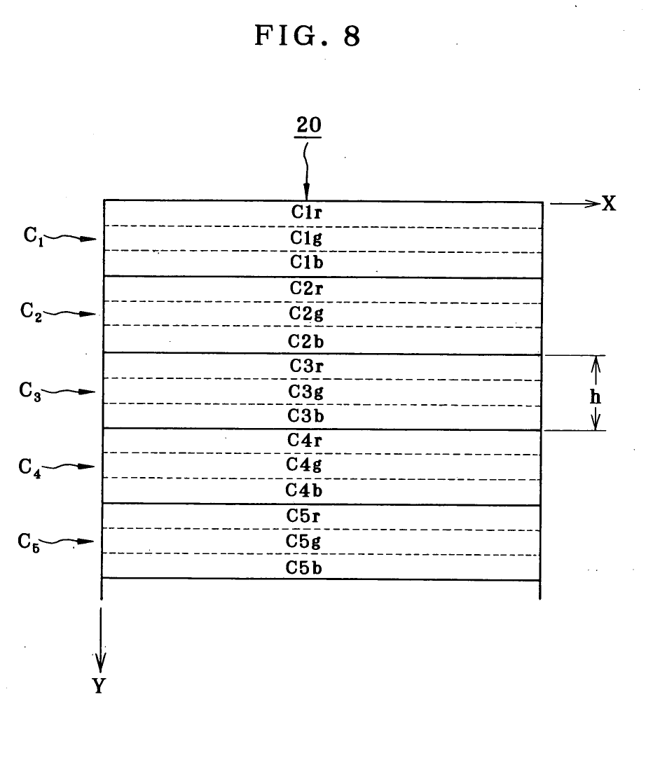

Recording the object in the same CGH 10 in such a way that the image of the object is reconstructed with a plurality of wavelengths may be implemented in the mode of patent publication 4 proposed by the inventor. Reference is now briefly made to that mode. As depicted in FIG. 8, the recording surface 20 of a CGH 10 is divided in a vertical (Y) direction into two-dimensional unit areas C₁, C₂, C₃, . . . , Cₘ, . . . , each having a minute width h. Each two-dimensional unit area is vertically divided into three unit sub-areas. Interference fringe data for the primary color R (red) separation image of the object to be recorded are recorded in all unit sub-areas C₁ᵣ, C₂ᵣ, C₃ᵣ, . . . , Cₘᵣ, . . . ; interference fringe data for the primary color G (green) separation image of the object to be recorded are recorded in all unit sub-areas C_{1g}, C_{2g}, C_{3g}, . . . , C_{mg}, . . . ; and interference fringe data for the primary color B (blue) separation image of the object to be recorded are recorded in all unit sub-areas C_{1b}, C_{2b}, C_{3b}, . . . , C_{mb}, . . . . In the embodiment of FIG. 1, interference fringe data for the shielding block 12 to be reconstructed in red with reconstructing diffracted light having a red wavelength are recorded in discrete unit sub-areas C₁ᵣ, C₂ᵣ, C₃ᵣ, . . . . Cₘᵣ, . . . ; and interference fringe data for the minute object 11 to be reconstructed in blue with reconstructing diffracted light having a blue wavelength are recorded in discrete unit sub-areas C_{1b}, C_{2b}, C_{3b}, . . . , C_{mb},

Thus, to record the shielding block 12 and minute object 11 in different colors in the recording surface 20 of the CGH 10 such that they can be reconstructed at the same time, the recording surface 20 is divided into minute R, G and B areas. Then, the interference fringe data for the primary color R separation image are discretely recorded in the R areas; the interference fringe data for the primary color G separation image are discretely recorded in the G areas; and the interference fringe data for the primary color B separation image are discretely recorded in the B areas. When the reconstructed image has parallax in the horizontal direction only, it is preferable that each unit sub-area extends in the horizontal direction of each minute width, as shown in FIG. 8 by way of example but not by way of limitation.

The shielding block 12 used herein may be either an ordinary 2 or 3D object or an object comprising a diffraction grating pattern provided on the surface of the CGH 10 and known from, for instance, patent publications 1, 5 and 6. In this case, a pattern constructed of a diffraction grating that is the shielding block 12 is directly recorded in a corresponding area on the surface of the CGH 10 rather than recorded as a hologram.

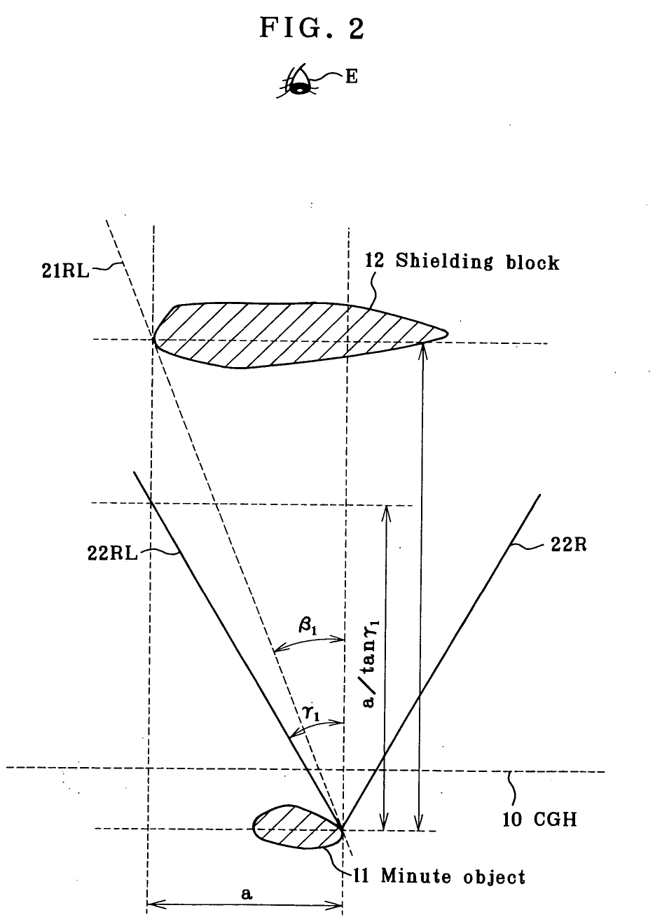

Referring further to patent publication 3, the arrangement of FIG. 2 differs from that of FIG. 1 in that in order to allow a minute object 11 to be fully visible from a direction different from the front direction, for instance, from an obliquely left-hand direction, the angle of radiation, γ₁, of object light from the minute object 11 is larger than the angle β₁ of a straight line 21RL connecting the right end of the minute object 11 with the left end of the shielding block 12 with respect to the front direction. To put it another way, when a plane plate is placed between the shielding block 12 and the minute object 11, the angle of radiation, γ₁, of object light from the minute object 11 is larger than the angle β₁ at which the tilting of the plane plate maximizes. In FIG. 2, a straight line 22RL is indicative of the left-hand limit to the object light. The same holds true for where the aforesaid different direction is changed to an obliquely right-hand direction. In other words, if the space in the front direction between the shielding block 12 and the minute object 11 is made equal to or greater than a/tan γ where γ is the angle of radiation of the object light from the minute object 11 and a is the width from the right or left end of the minute object 11 to the left or right end of the shielding block 12, then the minute object 11 is fully visible from an obliquely left-hand or right-hand direction.

In this embodiment, too, the shielding block 12 and the minute object 11 are recorded in different colors, for instance, such that the shielding block 12 is reconstructed in red with diffracted light having a red wavelength, and the minute object 11 is reconstructed in blue with diffracted light having a blue wavelength.

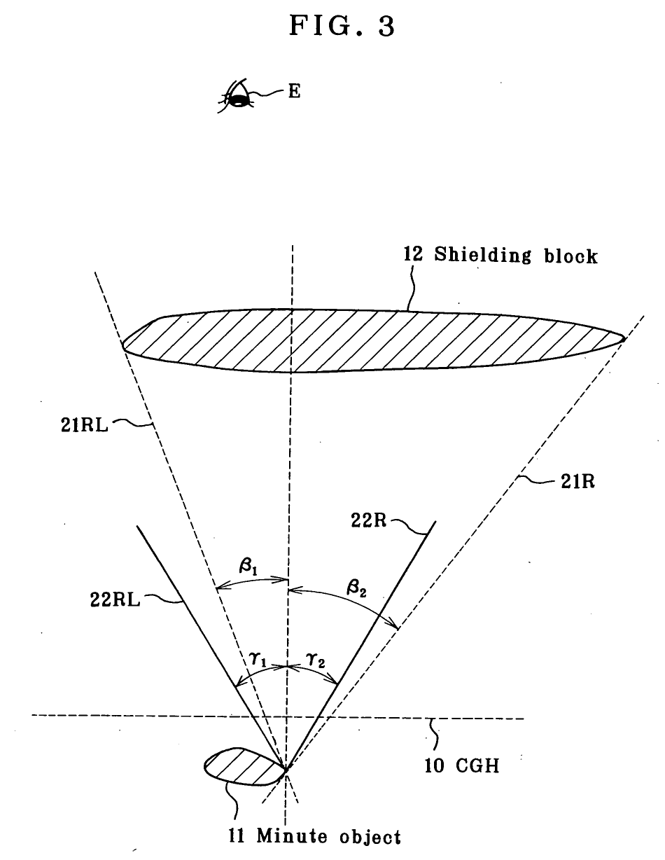

In FIG. 3, a straight line 22R indicative of a right-hand boundary to object light emerging from the right end of a minute object 11 is located inside a straight line 21R passing by the right ends of the minute object 11 and a shielding block 12, and a straight line 22RL indicative of a left-hand boundary to object light leaving the right end of the minute object 11 is located outside a straight line 21RL passing by the right end of the minute object 11 and the left end of the shielding block 12. In this case, the minute object 11 is fully visible on the left side, but, on the other side or the right side, it is fully hidden by the shielding block 12 and so is invisible. In terms of angle, the left-hand angle of radiation, γ₁, of object light from the minute object 11 is larger than the angle β₁ of a straight line 21RL connecting the right end of the minute object 11 with the left end of the shielding block 12 with respect to the front direction, and the right-hand angle of radiation, γ₂, of object light from the minute object 11 is smaller than the angle β₂ of a straight line 21R connecting the right end of the minute object 11 with the right end of the shielding block 12 with respect to the front direction.

In this embodiment, too, the shielding block 12 and the minute object 11 are recorded in different colors, for instance, such that the shielding block 12 is reconstructed in red with diffracted light having a red wavelength, and the minute object 11 is reconstructed in blue with diffracted light having a blue wavelength.

Referring back to FIG. 1, the right-hand angle of radiation, γ₂, of object light from the minute object 11 is larger than the angle β₂ of the straight line 21R connecting the right end of the minute object 11 with the right end of the shielding block 12 with respect to the front direction, and the left-hand angle of radiation, γ₃, of object light leaving the minute object 11 is larger than the angle β₃ of a straight line 21L connecting the left end of the minute object 11 with the left end of the shielding line 21L connecting the left end of the minute object 11 with the left end of the shielding block 12 with respect to the front direction. In this case, the range of angle wherein the minute object 11 is partly or wholly visible is found to become γ₂−β₂+γ₃−β₃ from FIG. 1. On the other hand, the range of angle of wherein the minute object 11 is hidden by the shielding block 12 is found to become β₂+β₃. Here, if γ₂−β₂+γ₃−β₃ is equal to or less than ½ of β₂+β₃, then the effect on the shielding of the minute object 11 that is authenticating information is much more enhanced; that the minute object 11 has been recorded as authenticating information is difficult to see through, ensuring even higher counterfeit-proofness.

Here the case where the right-hand angle of radiation, γ₂, of object light is smaller than the angle β₂ so that, on the right side, the minute object 11 is fully hidden by the shielding block 12 and so is invisible is defined by γ₂=β₂, and the case wherein the left-hand angle of radiation, γ₃, of object light is smaller than the angle β₃ so that, on the left side, the minute object 11 is fully hidden by the shielding block 12 and so is invisible is defined by γ₃=β₃. Then, the aforesaid relations may be written as
|γ₂−β₂|+|γ₃−β₃|≦½×(|β₂|+|β₃|)

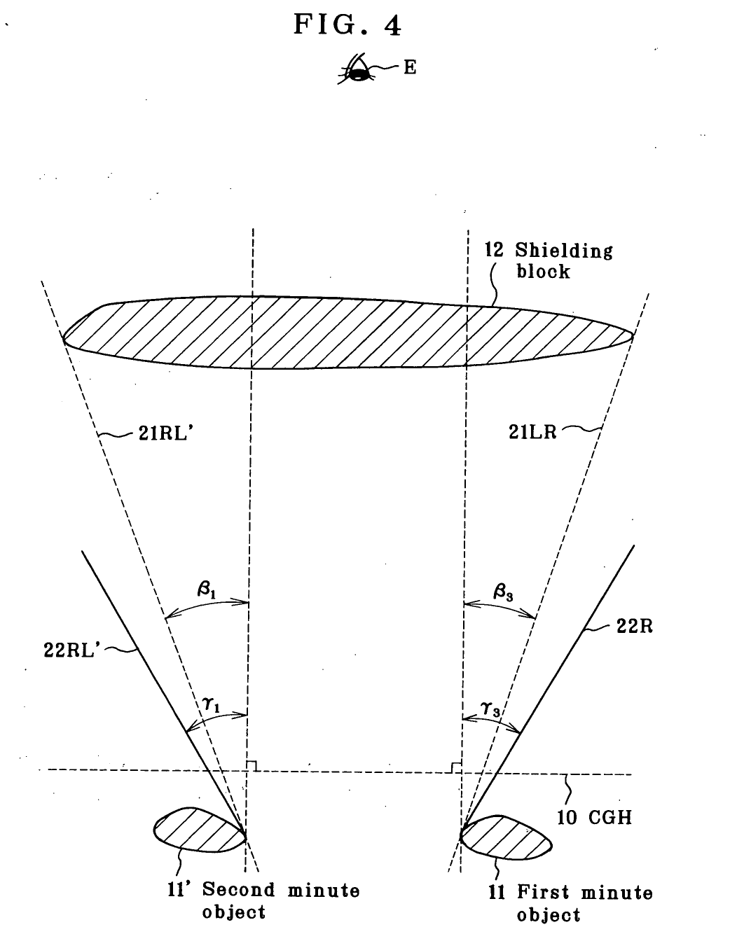

Referring then to FIG. 4, two minute objects 11, 11′are recorded such that the first minute object 11 is fully visible in the angle range γ₃−β₃ on the right side but, on the left side, it is fully hidden and so is invisible while the minute object 11′ is fully visible in the angle range γ₁−β₁ on the left side but, on the right side, it is fully hidden and so is invisible. This embodiment ensures much higher counterfeit-proofness because the minute objects viewed on the right and left side of the shielding block 12 differ from each other.

In this embodiment, the shielding block 12, the minute object 11 and the minute object 11′ are recorded in mutually different colors, for instance, such that the shielding block 12 is reconstructed in red with diffracted light having a red wavelength; the minute object 11 is reconstructed in yellow by additive color mixing of diffracted light having red and green wavelengths; and the minute object 11′ is reconstructed in blue with diffracted light having a blue wavelength. On the recording surface 20 of FIG. 8 here, interference fringe data for the shielding block 12 and minute object 11 to be reconstructed in red with diffracted light having a red wavelength are recorded in discrete unit sub-areas C₁ᵣ, C₂ᵣ, C₃ᵣ, . . . , Cₘᵣ, . . . ; interference fringe data for the minute object 11′ to be reconstructed in blue with diffracted light having a blue wavelength are recorded in discrete unit sub-areas C_{1b}, C_{2b}, C_{3b}, . . . , C_{mb}, . . . ; and interference fringe data for the minute object 11 to be reconstructed in green with diffracted light having a green wavelength are recorded in discrete unit sub-areas C_{1g}, C_{2g}, C_{3g}, C_{mg}, . . . .

In the hologram of the present invention as explained above, the authenticating information (minute objects 11, 11′) that is as small as cannot visually be perceived is recorded therein. Accordingly, even when the hologram is irradiated with proper illumination light, the presence of that authenticating information is greatly unlikely to be noticeable. Furthermore, even when viewed on an enlarged scale under a loupe or the like, the presence of the authenticating information is little noticeable from an ordinary viewing direction, e.g., from the front. Thus, the concealability of the authenticating information is much more enhanced, considerably reducing the risk of forgery.

For the purpose of authentication, the hologram of the present invention is observed on an enlarged scale under a loupe or the like while illuminated with proper white light. As, in this state, the hologram is observed from a direction other than the ordinary front direction, the authenticating information (minute objects 11, 11′) comes out in a color different from that of the shielding block 12. As the position of viewing is moved to the front position that is in the ordinary viewing direction, the authenticating information 11, 11′ is hidden by the shielding block 12 and so is not exposed to view. In this way, the hologram of the present invention is authenticated.

Further, if the hologram of the present invention is designed such that the minute object 11 does not develop from one side (the right side of FIG. 3) that is opposite to the other side on which the minute object 11 comes out from the shielding block 12 (the left side of FIG. 3) as shown in FIG. 3, the concealability of the authenticating information is then much more enhanced.

Furthermore, if the hologram of the present invention is designed such that the second minute object 11′ comes out on one side that is opposite to the other side on which the minute object 11 comes out from the shielding block 12 as shown in FIG. 4, its counterfeit-proofness is much more enhanced.

Note here that the more away the minute object 11 is located from the surface of the CGH 10, the more the reconstructed image of the minute object 11 is blurred and so the more difficult the image is to view. Thus, it is desired that the minute objects 11, 11′ be spaced at most 1 mm away from the surface of the CGH 10.

The boundary of diffracted light for the reconstruction of the minute object 11 or the angle of radiation of object light has been described as being determined by the hidden surface removal processing for CGH fabrication. Even when a hologram is fabricated by two-beam interference, however, an equivalent hologram may be fabricated by using a mask or the like to limit the range of incidence on a hologram medium of object light from the minute object to be recorded. Thus, the present invention is applicable not only to CGHs but also to holograms fabricated by a conventional two-beam interference process.

In use, the hologram of the present invention having authenticating information recorded therein may be applied onto the articles desired to be counterfeit-proof such as cards or documents.

Whether or not a certain hologram has authenticating information recorded therein may be checked as follows. The hologram of the present invention is designed such that the authenticating information is viewable only from a specific direction predetermined depending on a specific direction of illumination with reconstructing light. Thus, with an authenticating information check system comprising an illumination optical system and a viewing optical system located in that direction, it is easy to test for genuineness of holograms, and cards, documents or the like onto which they are applied.

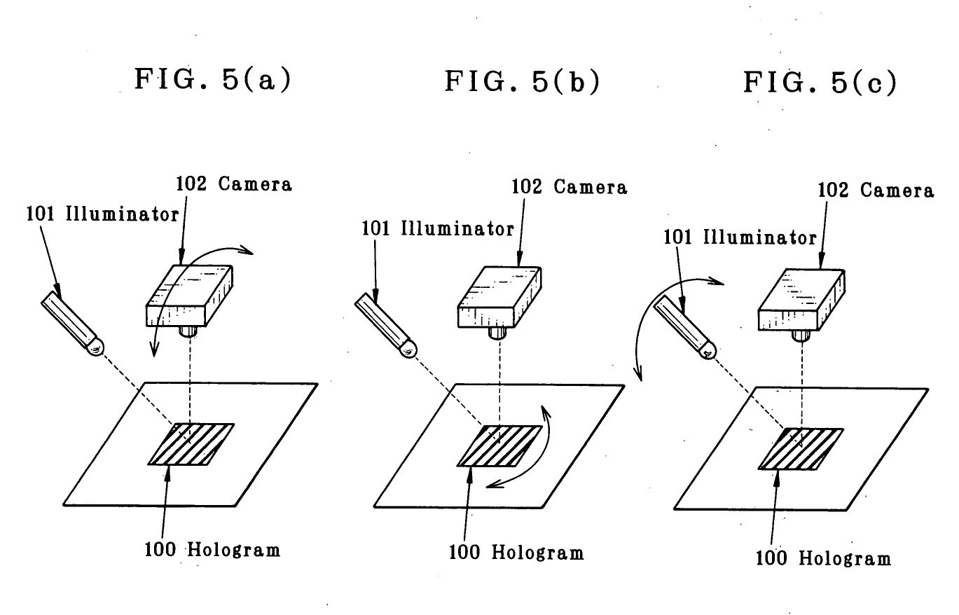

Some exemplary authenticating information check systems are now explained with reference to FIG. 5. In one check system of FIG. 5(a), a hologram 100 (corresponding to the CGH 10 in FIGS. 1-4) having minute objects 11, 11′ and a shielding block 12 recorded therein according to the present invention and an illuminator 101 for illuminating the hologram 100 with reconstructing illumination light are fixedly provided together with a relatively movable camera 102 for viewing the recorded authenticating information on an enlarged scale, so that the direction capable of viewing the authenticating information can be determined.

In another check system of FIG. 5(b), an illuminator 101 for irradiating a hologram 100 with reconstructing illumination light and a camera 102 for viewing authenticating information recorded in the hologram 100 on an enlarged scale are fixedly provided while the hologram 100 is relatively rotatable, thereby finding the direction capable of viewing the authenticating information. When the hologram 100 is a relief hologram such as a computer-generated hologram, the selectivity of angle by reconstructing illumination light is not very high; even when the illuminator 102 is moved with respect to the hologram 100, the recorded minute objects 11, 11′ and shielding block 12 are reconstructed while they are moved. Accordingly, the authenticating information can be viewed where the hologram 100 arrives at a given position, at which whether or not the authenticating information can then be checked.

In yet another check system of FIG. 5(c), a hologram 100 and a camera 102 for viewing authenticating information recorded in the hologram 100 on an enlarged scale are fixedly provided while an illuminator 101 for irradiating the hologram 100 with reconstructing illumination light is relatively movable, thereby determining which direction the authenticating information can be viewed. In this case, too, even though the illuminator 101 is moved with respect to the hologram 100, the recorded minute objects 11, 11′ and shielding block 12 are reconstructed while they are moved. When the illuminator 101 arrives at a given position, the authenticating information can be viewed; at that position, whether or not the authenticating information can actually be viewed is checked.

As already mentioned, when the hologram of the present invention is recorded as a relief hologram, wavelength selectivity is not very high. Thus, when a common white light source, for instance, a fluorescent lamp is used as the light source for the authenticating information check system 101, it is difficult to tell the colors of the minute objects 11, 11′ from that of the shielding block 12. Therefore, it is required that a white light source approximate to a point light source be used as the light source for the authenticating information check system 101.

It is here noted that a hologram wherein, as contemplated herein, a minute object is located behind a shielding block, so that the minute object is hidden by the shielding block in a given viewing direction and so is not exposed to view, but can be viewed from a direction different from said given direction, and the minute object and the shielding block are recorded in such a way as to be viewable in mutually different colors, could be recorded in the form of a holographic stereogram. The holographic stereogram, for instance, includes a computer-generated holographic stereogram as proposed in Japanese Patent Application No. 2003-101736, a one-step holographic stereogram obtained by laser holography for each pixel as proposed in patent publication 7, and a holographic stereogram as proposed in patent publication 8, wherein a Fourier transform pattern is recorded for each pixel; however, the computer-generated holographic stereogram as proposed in Japanese Patent Application No. 2003-101736 is particularly preferred because of having high resolution and a lot more parallaxes.

While the hologram having authenticating information recorded therein according to the present invention has been described with reference to its principles and examples, it is understood that the present invention is never limited thereto and so may be modified in various forms.

### POSSIBLE UTILISATION IN THE INDUSTRIES

In the hologram having authenticating information recorded therein according to the present invention, a minute object that is the authenticating information is located behind a shielding block of visually easy-to-perceive size, so that the authenticating information is hidden by the shielding block in a given viewing direction and so is not exposed to view, but can be viewed from a direction different from said given direction, and said authenticating information and said shielding block are recorded in such a way as to be viewable in mutually different colors; the presence of the authenticating information is little noticeable. Further, even when the hologram is viewed through a magnifying viewing means such as a loupe, the presence of the authenticating information is little noticeable from an ordinary viewing direction. The hologram of the present invention thus ensures that the concealability of the authenticating information is extremely enhanced, and so has much higher counterfeit-proofness. Furthermore, the authenticating information and the shielding block are viewable in mutually different colors, so that an authenticator can easily check the authenticating information.

What we claim is:

1. A 3D image-reconstruction hologram having authenticating information recorded therein, wherein:
a minute object that is the authenticating information is located behind a shielding block of visually easy-to-perceive size, so that the authenticating information is hidden by the shielding block in a given viewing direction and so is not exposed to view, but can be viewed from a direction different from said given direction, and said authenticating information and said shielding block are recorded in such a way as to be viewable in mutually different colors.

2. The hologram according to claim 1, wherein said minute object is of visually difficult-to-resolve size, and is viewable through a magnifying viewing means.

3. The hologram according to claim 1 or 2, wherein said given direction is a front direction with respect to said hologram.

4. The hologram according to any one of claims 1-3, which is recorded in a computer-generated hologram form.

5. The hologram according to any one of claims 1-4, wherein said minute object has a maximum size of 300 μm or less.

6. The hologram according to any one of claims 1-5, wherein said shielding block comprises a pattern constructed of a diffraction grating recorded in a hologram surface.

7. The hologram according to any one of claims 1-6, wherein said minute object is in a character form.

8. The hologram according to any one of claims 1-7, where said minute object has an angle of radiation of object light, at which the minute object is fully visible on one side of said shielding block.

9. The hologram according to any one of claims 1-8, wherein a distance between said minute object and said shielding block is determined such that said minute object is fully visible on one side of said shielding block in a direction different from said given direction.

10. The hologram according to any one of claim 8 or 9, wherein said minute object is invisible on one side that is opposite to the other side on which said minute object is fully visible.

11. The hologram according to any one of claims 1-10, wherein an angle range in which said minute object is partly or wholly visible is equal to or less than ½ of an angle range in which said minute object is hidden by said shielding block.

12. The hologram according to any one of claims 8-10, wherein another minute object is recorded such that said another minute object is viewable on one side that is opposite to the other side on which said minute object is fully visible.

13. The hologram according to any one of claims 1-12, wherein said minute object is reconstructed within 1 mm from a surface of said hologram.

14. The hologram according to any one of claims 1-13, which is applied onto a card or a document.

15. An authenticating information check system, wherein an illumination optical system and a viewing position are provided such that said minute object in the hologram having authenticating information recorded therein according to any one of claims 1-14 is viewable.

16. The authenticating information check system according to claim 15, wherein said hologram and said illumination optical system are fixedly provided while said viewing position is relatively movable.

17. The authenticating information check system according to claim 15, wherein said illumination optical system and said viewing position are fixedly provided while said hologram is relatively rotatable.

18. The authenticating information check system according to claim 15, wherein said hologram and said viewing position are fixedly provided while said illumination optical system is relatively movable.

19. A card or a document onto which the hologram according to any one of claims 1-14 is applied.
